(19) United States
(12) Patent Application Publication
(10) Pub. No.: US 2011/0230333 A1
(43) Pub. Date: Sep. 22, 2011

(54) Olefin Cracking Catalyst and Manufacturing Process

(75) Inventors: Timur V. Voskoboynikov, Arlington Heights, IL (US); Michael H. Quick, Arlington Heights, IL (US); John J. Senetar, Naperville, IL (US)

(73) Assignee: UOP LLC, Des Plaines, IL (US)

(21) Appl. No.: 12/724,446

(22) Filed: Mar. 16, 2010

(51) Int. Cl. B01J 29/06; B01J 29/83

(52) U.S. Cl. 502/68; 502/64; 502/75

(57) ABSTRACT

A new catalyst and method of preparing the catalyst is presented. The catalyst is a molecular sieve used for cracking olefins, and has improved selectivity to increase propylene yields and to reduce the amount of aromatics and methane produced. The catalyst been ion-exchanged to reduce the alkali composition in the catalyst.

### FIELD OF THE INVENTION

This invention relates to the catalyst for olefin cracking and the process of making an olefin cracking catalyst.

### BACKGROUND OF THE INVENTION

Ethylene and propylene, light olefin hydrocarbons with two or three atoms per molecule, respectively, are important chemicals for use in the production of other useful materials, such as polyethylene and polypropylene. Polyethylene and polypropylene are two of the most common plastics found in use today and have a wide variety of uses for both as a material fabrication and as a material for packaging. Other uses for ethylene and propylene include the production of vinyl chloride, ethylene oxide, ethylbenzene and alcohol. The production of light olefins is predominantly performed through steam cracking, or pyrolysis, of larger hydrocarbons. Hydrocarbons used as feedstock for light olefin production include natural gas, petroleum liquids, and carbonaceous materials including coal, recycled plastics or any organic material.

Methods are known for increasing the conversion of portions of the products of the ethylene production from a zeolitic cracking process to produce more ethylene and propylene by a disproportionation or metathesis of olefins. Such processes are disclosed in U.S. Pat. No. 5,026,935 and U.S. Pat. No. 5,026,936 wherein a metathesis reaction step is employed in combination with a catalytic cracking step to produce more ethylene and propylene by the metathesis of C₄ and heavier molecules. The catalytic cracking step employs a zeolitic catalyst to convert a hydrocarbon stream having 4 or more carbon atoms per molecule to produce olefins having fewer carbon atoms per molecule. The hydrocarbon feedstream to the zeolitic catalyst typically contains a mixture of 40 to 95 wt-% paraffins having 4 or more carbon atoms per molecule and 5 to 60 wt-% olefins having 4 or more carbon atoms per molecule. In U.S. Pat. No. 5,043,522, it is disclosed that the preferred catalyst for such a zeolitic cracking process is an acid zeolite, examples includes several of the ZSM-type zeolites or the borosilicates. Of the ZSM-type zeolites, ZSM-5 was preferred. It was disclosed that other zeolites containing materials which could be used in the cracking process to produce ethylene and propylene included zeolite A, zeolite X, zeolite Y, zeolite ZK-5, zeolite ZK-4, synthetic mordenite, dealuminized mordenite, as well as naturally occurring zeolites including chabazite, faujasite, mordenite, and the like. Zeolites which were ion-exchanged to replace alkali metal present in the zeolite were preferred. Preferred cation exchange cations were hydrogen, ammonium, rare earth metals and mixtures thereof.

European Patent No. 109,059B1 discloses a process for the conversion of a feedstream containing olefins having 4 to 12 carbon atoms per molecule into propylene by contacting the feedstream with a ZSM-5 or a ZSM-11 zeolite having a silica to alumina atomic ratio less than or equal to 300 at a temperature from 400 to 600° C. The ZSM-5 or ZSM-11 zeolite is exchanged with a hydrogen or an ammonium cation. The reference also discloses that, although the conversion to propylene is enhanced by the recycle of any olefins with less than 4 carbon atoms per molecule, paraffins which do not react tend to build up in the recycle stream. The reference provides an additional oligomerization step wherein the olefins having 4 carbon atoms are oligomerized to facilitate the removal of paraffins such as butane and particularly isobutane which are difficult to separate from C₄ olefins by conventional fractionation. In a related European Patent 109060B1, a process is disclosed for the conversion of butenes to propylene. The process comprises contacting butenes with a zeolitic compound selected from the group consisting of silicalites, boralites, chromosilicates and those zeolites ZSM-5 and ZSM-11 in which the mole ratio of silica to alumina is greater than or equal to 350. The conversion is carried out at a temperature from 500 to 600° C. and at a space velocity of from 5 to 200 kg/hr of butenes per kg of pure zeolitic compound. The European Patent 109060B1 discloses the use of silicalite-1 in an ion-exchanged, impregnated, or co-precipitated form with a modifying element selected from the group consisting of chromium, magnesium, calcium, strontium and barium.

The catalyst is one of the most capital intensive expenses in hydrocarbon processing. The improvement in catalysts can improve the life cycle of the catalyst, such that the catalyst can perform its cracking function for a longer period of time in the cycle between cracking and regeneration, thereby improving the return on investment in the catalyst.

### SUMMARY OF THE INVENTION

The present invention provides for a new catalyst for use in the cracking of olefins. The catalyst comprises a molecular sieve that has been steam treated to reduce the alkali metal content below 100 ppm by weight, and then acid washed. In one embodiment, the catalyst is a zeolite. The zeolite preferred for cracking olefins is a silicalite zeolite.

In another embodiment, the catalyst includes a binder, such as inorganic oxides, silica, alumina, silica-alumina, aluminum phosphate, titania, zirconia, and silica rich clays such as a kaolin clay.

Additional objects, embodiments and details of this invention can be obtained from the following detailed description of the invention.

### DETAILED DESCRIPTION OF THE INVENTION

The production of light olefins is an important process, and the amount and quality of light olefins can be enhanced through the selective cracking of larger olefins. The normal commercial processes for producing light olefins, such as steam cracking and catalytic cracking of hydrocarbon feedstocks, such as naphtha. These cracking processes often generate larger olefins that have lower value than ethylene or propylene. Typical process units that generate an olefinic feedstock include steam crackers, refinery FCC units, MTO units, and coker units. The process is an olefin cracking process and is integrated into refinery systems that generate olefin streams for converting larger olefins to light olefins. A typical feedstream comprises a paraffin and olefin composition having C4 to C8 hydrocarbons.

The process uses fixed bed reactors, where the process includes multiple reactor beds, and the process swings between different reactor beds. The off-line reactor beds are then regenerated during the operation of an on-line reactor bed. Keeping a reactor on line is important for the production of olefins, and a catalyst having a longer cycle time allows for keeping a reactor on line longer.

The operating conditions for the olefin cracking process includes temperatures between 500° C. and 600° C. with operating pressures between 200 to 600 kPa. The process uses a zeolitic catalyst and provides for a high propylene yield. The process is operated at high space velocity to achieve high conversion and high selectivity without using an inert diluent stream, and to minimize reactor size and operating costs.

The present invention is a catalyst for cracking olefins that has a longer cycle time. The catalyst is a molecular sieve that has been ion-exchanged with ammonium nitrate solution to reduce the alkali metal content to below 100 ppmw of the total molecular sieve weight. The catalyst is then steam treated and acid washed. The preferred catalyst for use in olefin cracking is a zeolite, and the preferred zeolite is silicalite. The silicalite has a high silica to alumina ratio, and preferably the ratio is greater than 400.

The catalyst is ion exchanged to remove alkali and alkaline earth ions. The ion exchange is performed with an ammonium compound, wherein the ammonium compound can comprise ammonium nitrate, ammonium sulfate, ammonium phosphate, or ammonium chloride. A preferred ammonium compound is ammonium nitrate.

The catalyst is ion-exchanged with ammonium nitrate solution to remove the alkali ions, and in particular sodium ions, Na⁺. The steam treatment comprises steaming the catalyst under a steam and inert gas atmosphere at a temperature greater than 500° C. Preferably, the steaming temperature is in the range from 700° C. to 800° C., with a more preferred steaming temperature between 720° C. and 740° C. The catalyst can be steam treated with 100% steam, or the steam treating step can comprise a combination of steam and inert gas. Inert gases include any inert gas that does not react with the catalyst, including nitrogen and argon, or a mixture of inert gases.

The catalyst is then acid washed with a mineral acid. The preferred mineral acid is nitric acid. Acid washing of a catalyst can remove non-framework alumina to make for a more stable catalyst.

The catalyst can further include a binder. Binders provide hardness and attrition resistance to the catalyst. The binder can comprise between 10% and 90% of the total catalyst weight. The binder aids in forming or agglomerating the crystalline particles.

When forming the catalyst product, the catalyst has a composition between about 15 weight % and about 50 weight % of the dried catalyst product. The binder in the catalyst product forms between 10 weight % and about 90 weight % of the dried catalyst product. The binder is preferably between 10 and 80 wt % and more preferably between 20 and 70 wt % of the catalyst.

Useful binders include inorganic oxides, silica, alumina, silica-alumina, aluminum phosphate, titania, zirconia, and silica rich clays such as a kaolin clay. Preferably the binder comprises silica. The term silica-alumina is not just a physical mixture of silica and alumina, but means an acidic and amorphous material that has been cogelled or coprecipitated. In this respect, it is possible to form other cogelled or coprecipitated amorphous materials that will also be effective as adsorbents. These include silica-magnesias, silica-zirconias, silica-thorias, silica-berylias, silica-titanias, silica-alumina-thorias, silica-alumina-zirconias, aluminophosphates, mixtures of these, and the like. The catalyst is then calcined at a temperature of at least 600° C.

Optionally, one can add a clay to the catalyst. The clay is added to the catalyst slurry before the mixing of the catalyst and binder, and the resultant slurry is mixed and spray dried. When adding clay, the clay forms between about 40 weight % and about 80 weight % of the dried catalyst product.

The normal procedure for manufacturing the catalyst is to first prepare the calcined zeolite. The zeolite is then bound and extruded with a binder, such as silica. The extruded catalyst is than calcined, ion exchanged, steamed, then acid washed, and calcined again.

In one embodiment, the catalyst produced is a zeolite comprising silicalite having a silica to alumina ratio greater than 400. The catalyst is ion exchanged with ammonium nitrate to remove alkali and alkaline earth ions content to below 100 ppmw. The catalyst is then steam treated at a temperature greater than 400° C., and preferably greater than 500° C. The steam treatment is a steam and inert gas atmosphere, where the inert gas is nitrogen. The catalyst is then acid washed with nitric acid. In a most preferred embodiment, the catalyst comprises between 60% and 90% by weight zeolite and between 10% and 30% by weight a binder comprising a silica compound.

Experiments performed show that the presence of sodium ions (Na+) is detrimental to selectivity of finished catalyst, i.e. a catalyst that has been steamed and washed. The catalyst used was a silicalite zeolite, with the formed catalyst comprising 70% by weight zeolite, and 30% by weight amorphous silica. Selectivity is significantly improved when the sodium ion concentration on the catalyst is reduced to below 100 ppm by weight of the catalyst, as measured by ICP (inductively coupled plasma) analysis on the formed catalyst. The catalysts were prepared in a laboratory, and using commercial equipment. When the catalyst had the sodium ion concentration reduced, the selectivity improved and undesirable products were reduced. Below, the results are shown in the table.

TABLE
Yields of propylene

| | Product yield, wt. % | | | C3=/tot. C3 | |
|---|---|---|---|---|---|
| Catalyst | C3= | Cl | BTX | wt. % | ppm Na |
| A | 15.5 | 1.3 | 3.9 | 92.1 | 174 |
| B | 15.3 | 0.8 | 2.3 | 94.0 | 50 |
| C | 16.3 | 1.6 | 4.8 | 91.0 | 180 |
| D | 15.1 | 0.7 | 2.0 | 94.5 | 40 |

The results are comparisons of catalysts A and C, prepared in a normal manner, wherein the sodium concentration is greater than 100 ppmw, and catalysts B and D where the sodium concentration has been reduced to less than 100 ppmw. Catalysts A and B were prepared in the laboratory, and catalysts C and D were commercially prepared catalysts. The steaming conditions were the same for each pair of samples: A and B, and C and D. The catalysts were then used in test reactors. A mixture of 40% isobutylene and 60% isobutane was reacted over the catalyst at reaction conditions. The reaction conditions included a feed inlet temperature of 580° C., and a WHSV of 13.5 hr⁻¹. The outlet pressure from the reactor was 150 kPa (7 psig).

The data shows that for high-Na catalyst, the steaming severity needs to be higher than for low-Na materials. If steaming severity is the same, the catalyst selectivity is low.

While the invention has been described with what are presently considered the preferred embodiments, it is to be understood that the invention is not limited to the disclosed embodiments, but it is intended to cover various modifications and equivalent arrangements included within the scope of the appended claims.

1. A catalyst having a longer cycle time for cracking olefins comprising:
a molecular sieve that is:
ion-exchanged to reduce the alkali metal content to below 100 ppmw; and
steam treated, and acid washed.

2. The catalyst of claim 1 wherein the molecular sieve is a zeolite.

3. The catalyst of claim 2 wherein the zeolite is a silicalite.

4. The catalyst of claim 3 wherein the zeolite has a silica to alumina ratio of equal or greater than 400.

5. The catalyst of claim 1 wherein the zeolite is ion exchanged to remove alkali and alkaline earth ions.

6. The catalyst of claim 5 wherein the zeolite is ion exchanged with an ammonium compound selected from the group consisting of ammonium nitrate, ammonium sulfate, ammonium phosphate, ammonium chloride and mixtures thereof.

7. The catalyst of claim 1 further comprising a binder in an amount between 10% and 90% by weight of the total catalyst weight, wherein the binder is selected from the group consisting of inorganic oxides, silica, alumina, silica-alumina, aluminum phosphate, titania, zirconia, silica rich clays, and mixtures thereof.

8. The catalyst of claim 7 wherein the binder comprises silica.

9. The catalyst of claim 1 wherein the steam treatment comprises steaming the catalyst under a steam and inert gas atmosphere at a temperature greater than 500° C.

10. The catalyst of claim 9 wherein the steam treatment comprises a steam atmosphere, or an atmosphere comprising steam and an inert gas.

11. The catalyst of claim 10 wherein the steam treatment includes nitrogen as the inert gas.

12. The catalyst of claim 1 wherein the acid washing comprises washing with nitric acid.

13. The catalyst of claim 1 wherein the alkali metal is sodium.

14. A catalyst having a longer life for cracking olefins comprising:
a zeolite, comprising silicalite and having a silica to alumina ratio equal to or greater than 400, that is:
ion-exchanged to reduce the sodium content to below 100 ppmw, then steam treated wherein the steam treatment is under steam atmosphere, or a steam and inert gas atmosphere, at a temperature greater than 400° C.; and
acid washed.

15. The catalyst of claim 14 wherein the zeolite is ion exchanged to remove alkali and alkaline earth ions.

16. The catalyst of claim 14 wherein the zeolite is ion exchanged with an ammonium compound.

17. The catalyst of claim 14 further comprising a binder in an amount between 10% and 90% by weight of the total catalyst weight.

18. The catalyst of claim 14 wherein the steam treatment comprises steaming the catalyst under a steam atmosphere, or a steam and inert gas atmosphere, at a temperature greater than 500° C.

19. The catalyst of claim 14 wherein the acid washing comprises washing with nitric acid.

20. The catalyst of claim 14 further comprising calcining the catalyst at a temperature of at least 600° C.
